(19) United States
(12) Patent Application Publication
(10) Pub. No.: US 2024/0160962 A1
(43) Pub. Date: May 16, 2024

(54) Modular System for Automated Substitution of Forecasting Data

(71) Applicant: ZEBRA TECHNOLOGIES CORPORATION, Lincolnshire, IL (US)

(72) Inventors: Suvarna S. Krishnan, Westwood, MA (US); Savita Nitin Kolap, Pune (IN); Amrit Raj Nigam, Norwood, MA (US); Vishv Garg, Gurgaon (IN)

(21) Appl. No.: 17/985,690

(22) Filed: Nov. 11, 2022

(51) Int. Cl. G06N 5/04

(52) U.S. Cl. CPC G06N 5/04

(57) ABSTRACT

A method includes: storing, for a plurality of facilities, respective facility datasets including (i) facility attributes, and (ii) historical time series of values for a plurality of performance metrics; obtaining an identifier of a target one of the facilities; selecting a set of candidate facilities from the plurality of the facilities; obtaining a similarity evaluation stack configuration; for each candidate facility, generating a similarity indicator based on (i) the respective facility attributes, (ii) the respective historical time series, and (iii) the similarity evaluation stack configuration; selecting, based on the similarity indicators, one of the candidate facilities; and substituting the historical time series of the selected candidate facility for the historical time series of the target facility in a forecasting mechanism.

### BACKGROUND

Operation of retail facilities and the like includes coordinating a variety of factors, including inventory and staffing. Selecting inventory quantities, staffing allocations and the like for a future period can be assisted by forecasting mechanisms based on historical data for the facility. In some cases, however, historical data may be unavailable, or the volume of such historical data may be insufficient for forecasting.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for automated substitution of forecasting data.

FIG. 2 is a flowchart of a method for automated substitution of forecasting data.

FIG. 3 is a diagram illustrating example facility attributes in the system of FIG. 1, employed in the performance of block 220 of the method of FIG. 2.

FIG. 4 is a diagram illustrating example configuration data employed at block 225 of the method of FIG. 2.

FIG. 5 is a flowchart of an example method of performing block 230 of the method of FIG. 2.

FIG. 6 is a diagram illustrating an example performance of the method of FIG. 5.

FIG. 7 is a diagram illustrating another example performance of block 230 of the method of FIG. 2.

FIG. 8 is a diagram illustrating a further example performance of block 230 of the method of FIG. 2.

FIG. 9 is a diagram illustrating a further example performance of block 230 of the method of FIG. 2.

FIG. 10 is a diagram illustrating an example performance of block 240 of the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method, including: storing, for a plurality of facilities, respective facility datasets including (i) facility attributes, and (ii) historical time series of values for a plurality of performance metrics; obtaining an identifier of a target one of the facilities; selecting a set of candidate facilities from the plurality of the facilities; obtaining a similarity evaluation stack configuration; for each candidate facility, generating a similarity indicator based on (i) the respective facility attributes, (ii) the respective historical time series, and (iii) the similarity evaluation stack configuration; selecting, based on the similarity indicators, one of the candidate facilities; and substituting the historical time series of the selected candidate facility for the historical time series of the target facility in a forecasting mechanism.

Additional examples disclosed herein are directed to a computing device, including: a memory storing, for a plurality of facilities, respective facility datasets including (i) facility attributes, and (ii) historical time series of values for a plurality of performance metrics; and a processor configured to: obtain an identifier of a target one of the facilities; select a set of candidate facilities from the plurality of the facilities; obtain a similarity evaluation stack configuration; for each candidate facility, generate a similarity indicator based on (i) the respective facility attributes, (ii) the respective historical time series, and (iii) the similarity evaluation stack configuration; select, based on the similarity indicators, one of the candidate facilities; and substitute the historical time series of the selected candidate facility for the historical time series of the target facility in a forecasting mechanism.

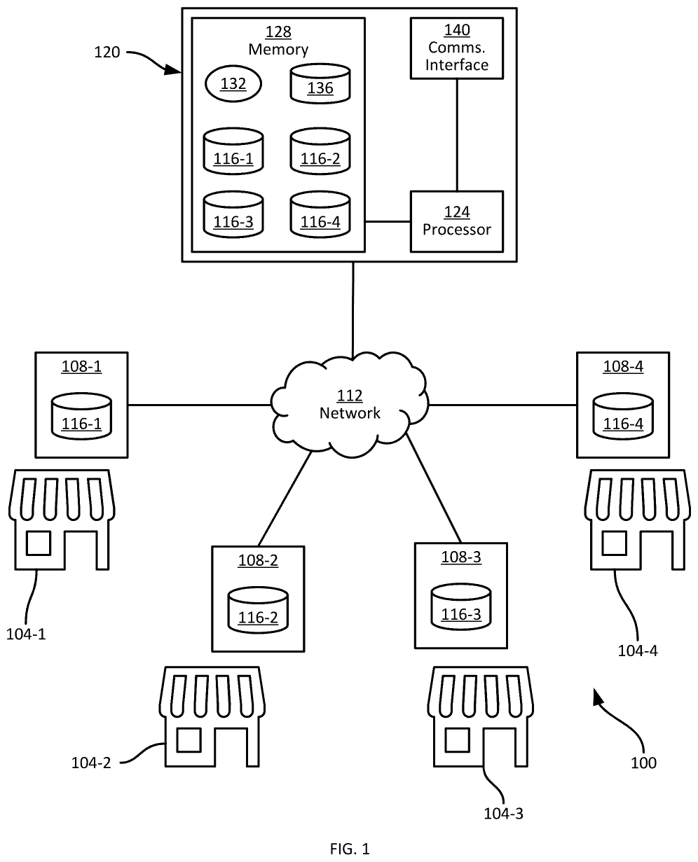

FIG. 1 illustrates a system 100 for automated substitution of forecasting data. The system includes a plurality of facilities, such as retail facilities 104-1, 104-2, 104-3, and 104-4 (collectively referred to as the facilities 104, and generically referred to as a facility 104; similar nomenclature is used below for other components). The system 100 can include a smaller or greater number of facilities 104 in other examples. The facilities 104 can include any of a wide variety of retailers, e.g., grocers or the like. Further, the facilities 104 can be associated with one another, e.g., by common ownership. For example, the facilities 104 can be individual franchise locations associated with a shared franchisee organization. The facilities 104 can also be individual locations commonly owned and operated by a single organization.

The facilities 104 are geographically distinct, in that each facility 104 is at a different geographic location than the other facilities 104. The facilities 104 can further share certain attributes, such as the range of products sold at each facility 104. The facilities 104 need not be identical. For example, in an example system 100 where the facilities 104 are grocery stores, one facility 104 may include a produce department and a bakery department, while another facility 104 may include a produce department but lack a bakery department.

The facilities 104 can include or be associated with respective computing devices 108-1, 108-2, 108-3, and 108-4. The computing devices 108 can be deployed on-premises at the facilities 104, but in other examples may be deployed at distinct physical locations and connected to local computing devices, e.g., via a network 112 (e.g., any suitable combination of local- and wide-area networks). The computing devices 108 are configured to collect and/or generate a wide variety of data corresponding to the respective facilities 104, e.g., in the form of performance metrics. Example performance metrics vary according to the nature of the facilities 104, and in the context of retail facilities, can include staffing-related data such as a count of on-duty staff per day, per hour, or the like, sales-related data such as revenue generated at the corresponding facility 104 per day, or the like. The performance metrics can also include measurements of customer traffic (e.g., customers in the corresponding facility 104 per hour, per day, or the like), quantities of various types of inventory received at the facility 104, moved from storage to a customer-facing area, sold, and the like.

The performance metrics mentioned above can be stored in repositories 116-1, 116-2, 116-3, and 116-4 maintained at each computing device 108. For example, each repository 116 can contain one or more time series of historical performance metrics (e.g., values for each metric recorded at any suitable frequency). The repositories 116 can also contain facility attributes, such as a location of the corresponding facility 104 (e.g., a mailing address and/or geographic coordinates), department identifiers (e.g., bakery, produce, butcher, and the like) present at the facility 104, a target staff count at the facility 104, and the like. Further examples of facility attributes include a size (e.g., in square feet or the like) of the facility 104, a number of entrances and exits of the facility 104, store hours (e.g., the hours the facility 104 is open to customers), and the like.

To generate forecast data, such as future staffing and/or inventory requirements, an operator at a given facility 104 can employ the historical time series for at least one performance metric in the corresponding repository 116. For example, one or more forecasting mechanisms can be used to determine trends in the historical data, and extrapolate those trends over a future time period (e.g., a week, a month, or any other suitable time period). For example, the historical data may indicate seasonal trends corresponding to increased purchases of certain goods, and the forecast data may therefore suggest larger orders of certain inventory items.

In some examples, the historical data stored in a repository 116 may be insufficient for use in forecast generation. For example, a facility 104 may have recently opened, or recently re-opened after a prolonged closure (e.g., for renovations). The corresponding repository 116 may therefore contain insufficient historical data to determine trends and generate forecast data. In the absence of sufficient local historical data (e.g., historical data in the repository 116 for a specific facility 104), some systems facilitate the selection of historical data from a different facility 104 for use in generating forecast data.

For example, as shown in FIG. 1, the system 100 can include a server 120, in communication with the computing devices 108 via the network 112. The server 120 can receive and store the historical data and/or facility attributes from the computing devices 108 for storage at the server 120. In the present example, the server 120 stores a copy of each repository 116 in memory, as shown in FIG. 1. For example, the computing devices 108 can periodically transmit locally collected performance metrics and facility attributes to the server 120.

In some systems, when insufficient historical data is available to generate a forecast for a facility (e.g., when the repository 116-1 contains insufficient data for generating forecasts for the facility 104-1), an operator at the relevant facility 104 can select historical data from another facility 104 (e.g., from the repository 116-3, corresponding to the facility 104-3) and substitute the selected historical data for the insufficient local historical data to generate a forecast. The selection of substitute data for forecasting, however, is made arbitrarily by the operator in such systems, and is dependent on the operator's knowledge of the similarities between the facility 104 for which insufficient data is available, and the facility 104 used as a substitute. In at least some cases, such substitution can lead to inaccurate forecasts, e.g., because the substitute data corresponds to a facility 104 that differs from the target facility in at least some respects.

The server 120 therefore implements additional functionality to automate the selection of substitute data, instead of relying on an arbitrary selection of substitute data by an operator of a facility 104. Further, the automated substitution of forecasting data implemented by the server 120 is modular, permitting modifications to the automated substitution functionality while mitigating the operational impacts of such modifications on the server 120 (e.g., by reducing downtime).

Certain internal components of the server 120 are illustrated in FIG. 1. In particular, the server 120 includes a processor 124 such as a central processing unit (CPU), graphics processing unit (GPU) or other suitable control circuit, connected with a non-transitory storage medium such as a memory 128. The memory 128 stores the repositories 116 as noted above, as well as a forecasting application 132 executable by the processor 124 to implement the automated data substitution functionality described below. The memory 128 also stores, in the illustrated example, configuration data 136 employed during execution of the application 132 for selecting substitute forecasting data for a given facility 104.

The server 120 also includes a communications interface 140 for communicating with other computing devices, such as the devices 108, via the network 112. The communications interface 140 includes suitable hardware (e.g. transmitters, receivers, network interface controllers and the like) allowing the server 120 to communicate with other computing devices. The components of the server 120 can be deployed in a housing, or distributed across a plurality of physical housings, e.g., in a geographically distributed cloud computing platform.

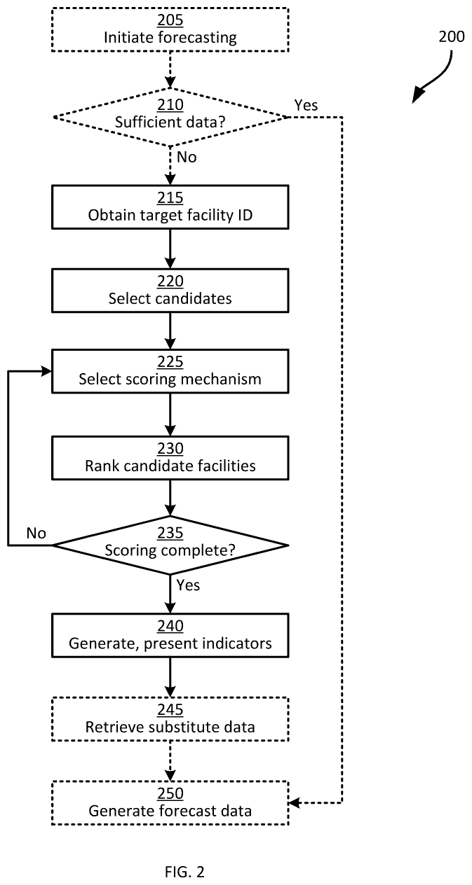

Turning to FIG. 2, a method 200 of automatically substituting forecast data is illustrated. The method 200 is described below in conjunction with an example performance of the method 200 within the system 100, and in particular by the server 120 via execution of the application 132.

Execution of the process set out below by the server 120 results in the selection of substitute historical data for generating forecast data for a given facility 104. In some examples, the process can be initiated in response to an unsuccessful attempt to generate forecast data for the facility 104 based on local historical data (e.g., corresponding to that facility 104). In particular, at block 205, the server 120 can receive a request to initiate forecasting for a given facility 104, e.g., as a command received from a computing device 108 at the relevant facility 104. For example, via execution of the application 132, the server 120 can host a web page or other interface through which operators of the facilities 104 can exchange data with the server 120. The server 120 can, for example, receive a request at block 205 to generate forecast data for the facility 104-1, e.g., from the computing device 108-1.

At block 210, the server 120 can be configured to determine whether sufficient historical data is available in the repository 116-1 to generate forecast data for the facility 104-1. When the determination at block 210 is affirmative, the server 120 is configured to proceed with forecast generation as discussed further below. Under some conditions, the determination at block 210 is negative. Example conditions resulting in a negative determination at block 210 include a number of values in one or more historical time series for the facility 104-1 being below a quantity threshold, and/or a number of missing values in one or more historical time series exceeding a missing-values threshold. For example, a historical time series of revenue values with a daily frequency may be stored in the repository 116-1. Any period of more than one day without a value indicates a missing value in the time series. When the time series has more than a threshold portion (e.g., 15%) of values missing over a configurable time period (e.g., six months), the determination at block 210 is negative.

When the determination at block 210 is negative, the server 120 proceeds to block 215. Further, in some examples the server 120 can initiate performance of the method 200 at block 215, i.e., omitting blocks 205 and 210. For example, an operator at a newly opened facility 104 may omit an attempt to generate forecast data based on historical data for that facility 104, and instead send a request to the server 120 to automatically select substitute data for use in forecasting.

At block 215, the server 120 is configured to obtain a target facility identifier. The target facility identifier can be a store number (e.g., in the case of a chain of locations, franchises, or the like), or any other suitable identifier distinguishing the facilities 104 from one another. Each repository 116 can include a unique facility identifier as an attribute, for example. The target facility 104 is a facility for which substitute data is to be selected via performance of the method 200. The target facility 104 can therefore be a facility for which a forecasting attempt was initiated at block 205, in some examples. As will be apparent, a target facility identifier can also be provided to the server 120 for a facility 104 for which sufficient historical data is available for forecasting. For example, the server 120 can be configured to periodically perform the method 200 for each of the facilities 104 (e.g., selecting an identifier of each facility 104 in turn as the target facility and performing the method 200 for that facility 104), and to store the identifier of another facility 104 identified as a suitable candidate for substitution, for future use.

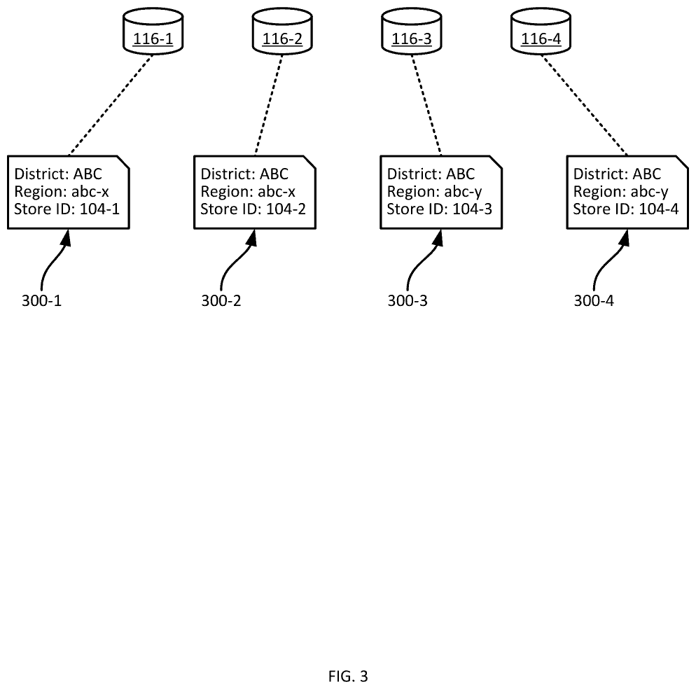

At block 220, having obtained an identifier of the target facility 104, the server 120 is configured to select a set of candidate facilities 104. The set of candidate facilities 104 can include all the facilities 104 other than the target facility 104 itself, in some examples. In other examples, an operator, e.g., via a computing device 108, can select candidate facilities 104 by applying one or more filter criteria to the complete set of facilities 104. For example, turning to FIG. 3, each repository 116 can include attributes 300-1, 300-2, 300-3, and 300-4 (only partial facility attributes are illustrated in FIG. 3, and it will be understood that the repositories 116 can also contain additional facility attributes).

Among the attributes 300 includes a facility identifier (also referred to in FIG. 3 as a “store ID”), and one or more organizational attributes, such as “district” and “region” indicators placing each facility 104 in a geographic hierarchy among the complete set of facilities 104. For example, a chain of facilities may include a plurality of districts each corresponding to distinct geographic areas, and each containing a plurality of regions corresponding to distinct geographic areas within the corresponding district. The hierarchy mentioned above can include further levels (e.g., corresponding to national and/or continental boundaries, branding-based groupings of facilities 104, and the like). An operator can select a proximity parameter such as one or more of the above organization attributes to select candidate facilities at block 220.

For example, an operator can communicate to the server 120, via the computing device 108-1, a selection of the district indicator, resulting in all three of the facilities 104-2, 104-3, and 104-4 being selected as candidates at the server 120, because all three facilities 104-2, 104-3, and 104-4 have district indicators “ABC” that match the district indicator of the target facility 104-1. In other examples, a selection of the region “abc-x” or the region “abc-y” would result in a smaller pool of candidate facilities 104 (i.e., only those facilities with region indicators matching the region indicator of the target facility 104). In further examples, the selection of candidates at block 220 need not involve the receipt of input from an operator at the facility 104-1. Instead, for example, the server 120 can maintain a default proximity indicator and select the candidate facilities 104 using the default proximity indicator.

In response to selecting the candidate facilities 104, the server 120 is configured, via the performance of blocks 225, 230 (e.g., iteratively, as discussed below), to generate a similarity indicator for each candidate facility 104. The similarity indicator for a given candidate facility 104 indicates how a degree to which the historical performance metrics for the candidate facility 104 are suitable for generating forecast data for the target facility 104. In other words, the similarity indicator for a candidate facility 104 indicates how effectively the historical data for the candidate facility 104 can be substituted for missing or otherwise insufficient historical data for the target facility 104, for the purpose of generating forecast data.

At block 225, the processor 124 retrieves the configuration data 136 (also referred to as a similarity evaluation stack configuration), and selects a scoring mechanism, also referred to as an evaluation mechanism, from the configuration data 136. The application 132, or a suite of associated applications, can implement a modular set of scoring mechanisms, and the determination of a similarity indicator for each candidate facility 104 is based on a selectable set of the available scoring mechanisms. The modularity of the scoring mechanisms permits similarity indicators to be generated using various selections of scoring mechanisms, executed in various orders. The configuration data 136 defines which scoring mechanisms are used for a given target facility 104, as well as the priority sequence in which the scoring mechanisms are executed.

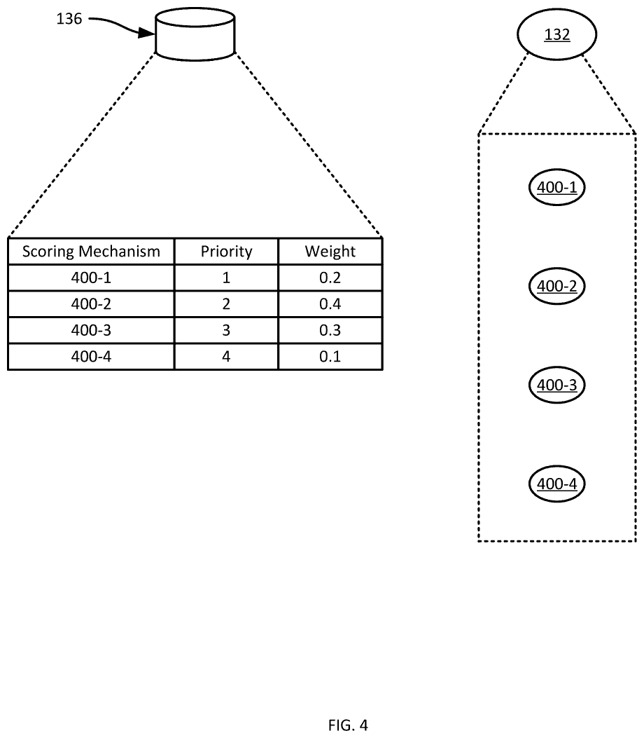

Turning to FIG. 4, certain details of the configuration data 136 and the application 132 are illustrated. In particular, the application 132 can include (e.g., as components of the application 132 itself as illustrated, or as separated but associated applications in the memory 128, in other examples) a set of evaluation mechanisms 400-1, 400-2, 400-3, and 400-4. In other examples, a greater number or a smaller number of evaluation mechanisms 400 can be deployed. Further, the number of evaluation mechanisms 400 implemented by the server 120 can vary over time, as the modular nature of the mechanisms 400 facilitates addition and/or removal of mechanisms, with little or no changes to the other mechanisms 400. In the present example, the evaluation mechanism 400-1 assesses the availability of certain performance metrics in connection with each candidate facility 104. The evaluation mechanism 400-2 assesses similarity between facility attributes of the target facility 104 and a candidate facility 104. The evaluation mechanism 400-3 assesses the proximity (e.g., the geographic proximity) of the candidate facility 104 and the target facility 104, and the evaluation mechanism 400-4 assesses the similarity between historical performance data for the candidate facility 104 and the target facility 104. A wide variety of other evaluation mechanisms may also be deployed, in addition to or instead of those discussed herein.

The configuration data 136, as shown in FIG. 4, includes identifiers of the evaluation mechanisms 400, and can also include either or both of a prioritization order of the evaluation mechanisms 400, and a weight for each of the evaluation mechanisms 400. The prioritization indicates the order of execution of the evaluation mechanisms, through iterated performances of blocks 225 and 230 of the method 200. In the present example, therefore, the evaluation mechanism 400-1 is executed first, followed in turn by the mechanisms 400-2, 400-3, and 400-4. In some examples, the priority of a given evaluation mechanism can be set to zero, or any other suitable null value, to disable that evaluation mechanism for a performance of the method 200. For example, the configuration data 136 can include multiple instances of the priorities and weights, e.g., for various types of facilities, and/or for each organizational parameter (e.g., a distinct set of priorities and weights for each region parameter). For some sets of facilities 104, a particular evaluation mechanism may be unnecessary for selection of substitute data, and may therefore be disabled.

The weights assigned to each of the evaluation mechanisms 400 indicate the relative magnitudes of the contributions of each evaluation mechanism 400 to the final similarity indicator of a candidate facility 104. That is, a greater weight assigned to an evaluation mechanism 400 indicates that that evaluation mechanism 400 has a greater impact on the resulting similarity indicator. The weights shown in FIG. 4 sum to a value of one, but need not do so in other examples.

At block 225, therefore, the processor 124 is configured to select an evaluation mechanism 400 according to the configuration data 136. In the present example, at the first instance of block 225, the processor 124 selects the evaluation mechanism 400-1. At block 230, the processor 124 is configured to rank the candidate facilities according to the selected evaluation mechanism 400. Ranking can be performed by determining a score for each candidate facility 104 and assigning ranks based on the scores, for example.

Each evaluation mechanism 400 assesses a certain set of inputs (e.g., performance metrics and/or facility attributes) via one or more criteria. The set of inputs, as well as the criteria, are different between the evaluation mechanisms 400. The evaluation mechanism 400-1 selected at a first performance of block 225 corresponds, in this example, to a data availability assessment. The data availability assessment mechanism determines whether the repository 116 for each candidate facility 104 contains historical data for performance metrics specified in the configuration data 136, and ranks the candidate facilities 104 according to the volume and/or completeness of available historical data for the specified performance metrics.

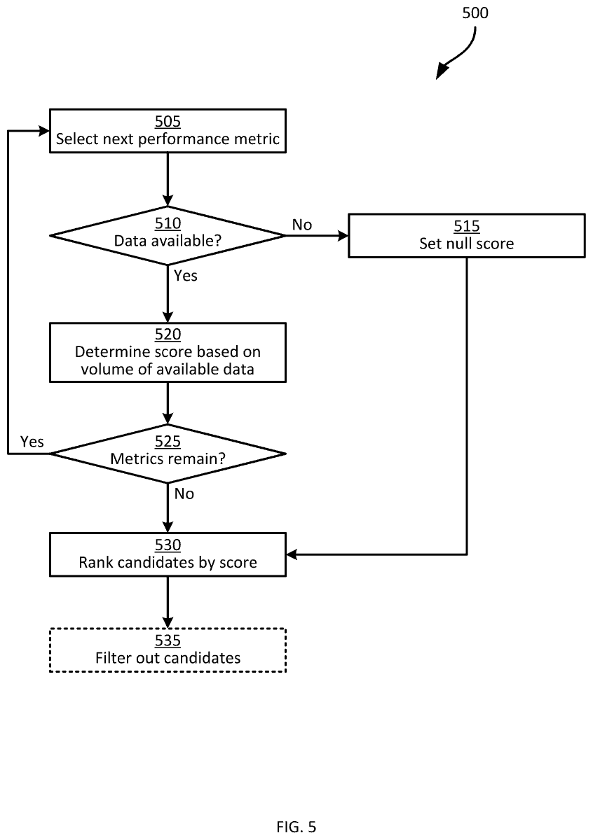

Turning to FIG. 5, a method 500 of performing block 230 is illustrated, in response to selection of the data availability assessment mechanism 400-1 at block 225. At block 505, the processor 124 selects a performance metric for assessment, from the configuration data 136. At block 510, the processor 124 is configured to determine, for each candidate facility 104, whether historical data is available in the corresponding repository 116 for the metric selected at block 505. When the determination at block 510 is negative, the corresponding candidate facility 104 is assigned a null score (e.g., a value of zero) at block 515. The absence of a specified performance metric indicates that the candidate facility 104 is unlikely to be suitable for use in forecasting for the target facility 104-1.

When the determination at block 510 is affirmative, the processor 124 is configured to determine a score for the corresponding candidate facility 104 at block 520, based on either or both of the volume and completeness of historical data for the specified performance metric from block 505. For example, a candidate facility 104 may be assigned a score that is proportional to the total number of data points for the performance metric over a defined time period (e.g., one year, or any other suitable time period). In other examples, a candidate facility 104 can be assigned a score component based on the length of a time period over which values for the selected metric are available in the corresponding repository (with longer periods of time translating to higher score components), and a further score component based on the number of missing data points over the time period (with fewer missing data points translating to higher score components). The score components can then be summed, for example.

At block 525, the processor 124 is configured to determine whether any performance metrics, e.g., as specified in the configuration data 136, remain to be assessed. When the determination at block 525 is affirmative, the processor 124 returns to block 505 and selects a further performance metric for assessment. When the determination at block 525, the processor 124 proceeds to block 530. When multiple performance metrics are assessed via blocks 505 to 520, the processor 124 can generate more than one score for each candidate facility, e.g., one per performance metric. As will be apparent, however, any candidate facility with no data available for a given performance metric is assigned a null score, and no further performance metrics are assessed for that candidate facility 104.

At block 530, the processor 124 is configured to rank the candidate facilities 104 by score. For example, the processor 124 can combine the scores determined for each performance metric, and rank the candidate facilities with the highest-scoring candidate being ranked first. At block 535, optionally, the processor 124 can filter out any candidates with null scores. That is, candidates having been assigned null scores can be discarded, and not assessed via any remaining evaluation mechanisms 400. Following block 530, or block 535 if included, the server 120 proceeds to block 235 of the method 200.

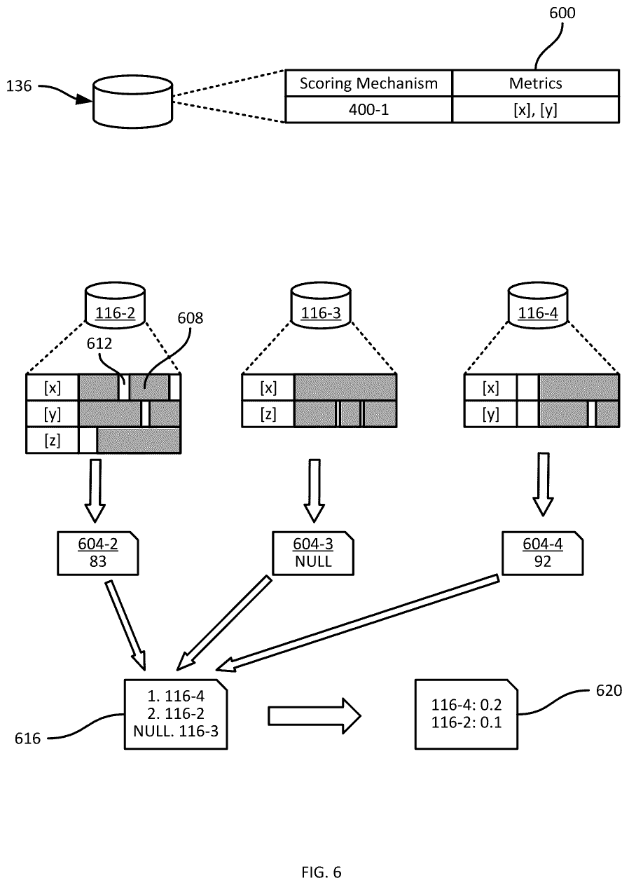

FIG. 6 illustrates an example performance of the method 500. In the illustrated example, the configuration data 136 includes indications 600 of performance metrics [x] and [y] to evaluate for availability via the evaluation mechanism 400-1. The server 120 is therefore configured to inspect the repositories 116-2, 116-3, and 116-4 (i.e., the historical data for each candidate facility 104) for the presence of each metric specified in the indications 600. As seen in FIG. 6, the repository 116-3 includes historical data for the metrics [x] and [z], but not the metric [y]. The facility 104-3 is therefore assigned a score 604-3 with a null value. The repositories 116-2 and 116-4 both contain data for the metrics [x] and [y], and the candidate facilities 104-2 and 104-4 are therefore scored based on the volume and/or completeness of the historical data. For example, shaded blocks 608 in the repositories 116 indicate available historical data, while white spaces 612 indicate missing values over certain periods of time. The performance of block 520 for each metric [x] and [y], for each candidate facility 104, yields a score 604-2 for the facility 104-2, and a score 604-4 for the facility 104-4. At block 530, the processor 124 generates a set of ranks 616 for the candidate facilities 104, in which the facility 104-4 is ranked first, and the facility 104-2 is ranked second. The facility 104-3 can be discarded from further evaluation. The processor 124 can also, at block 530, generate weighted similarity indicator components 620 based on the ranks 616. For example, the processor 124 can be configured to determine the inverse of the ranks 616, and to multiply the inverses by the corresponding weight shown in FIG. 4 (i.e., 0.2 in this example). As will be apparent, higher-ranking candidate facilities 104 therefore receive higher similarity indicator components 620. The facility 104-3, having been discarded, does not receive a similarity indicator component 620.

Returning to FIG. 2, at block 235 the processor 124 is configured to determine whether scoring for the candidate facilities 104 is complete. In other words, the processor 124 is configured to determine whether all the evaluation mechanisms 400 specified in the configuration data 136 have been executed. When the determination at block 235 is negative, the processor 124 returns to block 225, to select and execute the next evaluation mechanism. When the determination at block 235 is affirmative, the processor 124 proceeds to block 240. In the present example, the determination at block 235 is negative, because the evaluation mechanism 400-2, 400-3, and 400-4 have not yet been executed.

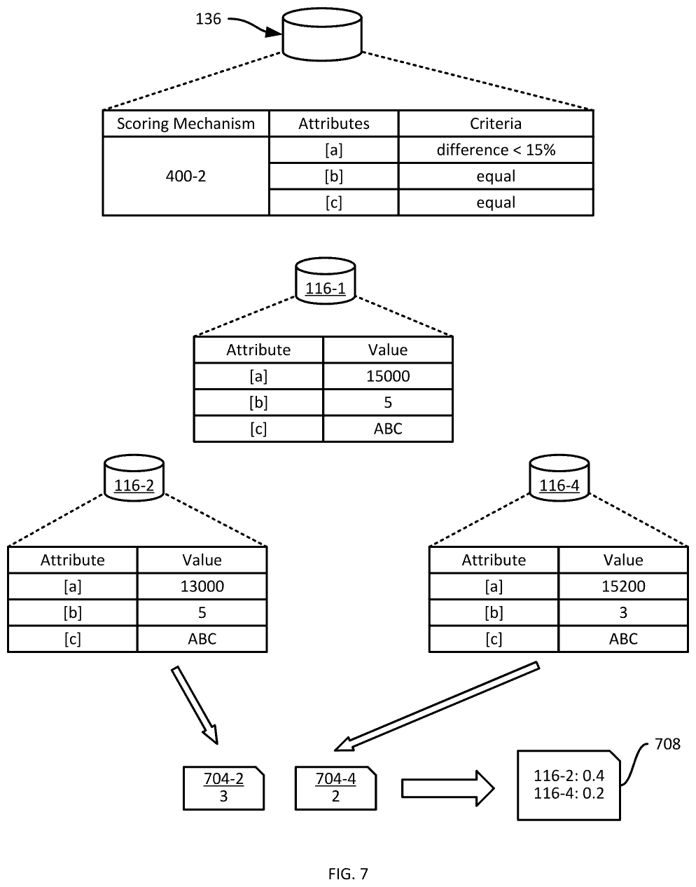

FIG. 7 illustrates an example performance of block 230 for the evaluation mechanism 400-2. The evaluation mechanism 400-2 determines, for each of a set of attributes specified in the configuration data 136, whether each candidate facility 104 has a value matching the corresponding value of the target facility 104. Whether a candidate facility 104 value “matches” can be defined in the configuration data 136. For example, some attributes may require exact matches, while other attributes may require matches within a certain threshold.

As shown in FIG. 7, the configuration data 136 identifies three attributes [a], [b], and [c], and criteria for assessing whether values for each attribute match. For example, values for the attribute [a] are considered to match if the difference between the value of the target facility 104 and the value for the candidate facility 104 is less than 15% of the value for the target facility. Values for the attributes [b] and [c] match only if they are equal (i.e., exact matches).

Values for the relevant attributes are shown for each of the target facility 104-1, the candidate facility 104-2, and the candidate facility 104-4. As seen from the example values, all three attributes for the candidate facility 104-2 match, and the two of the three attributes for the candidate facility 104-4 match. The processor 124 can, for example, generate scores 704-2 and 704-4 based on how many attributes for each candidate facility 104 match those of the target facility 104-1. The processor 124 can also generate similarity components 708, e.g., from weighted rankings, as discussed in connection with FIG. 6.

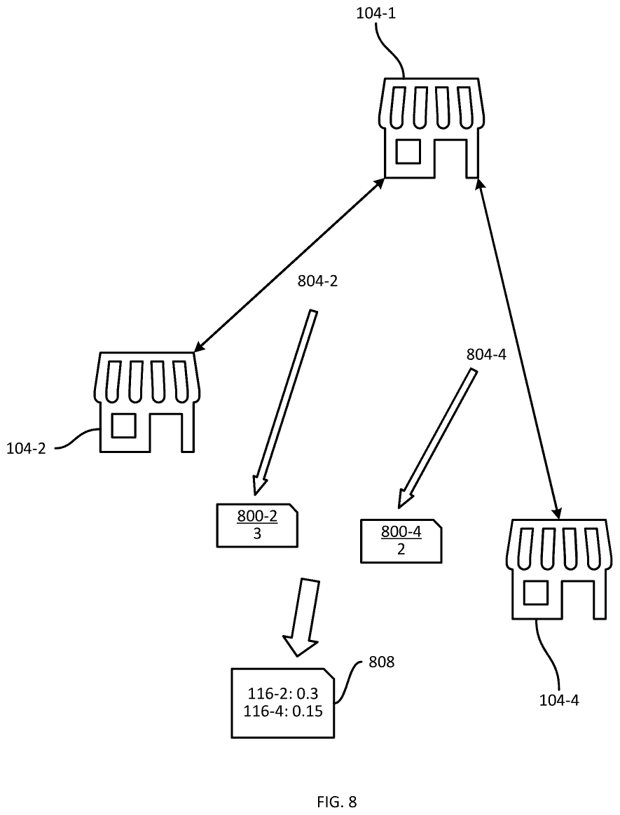

FIG. 8 illustrates a further example performance of block 230, for the evaluation mechanism 400-3. The evaluation mechanism 400-3 involves assigning scores 800-2 and 800-4 to the candidate facilities 104-2 and 104-4 based on geographic distances 804-2 and 804-4 between the facilities 104-2 and 104-4, and the target facility 104-1. Geographic distances can be determined by the server 120 based on facility locations (e.g., geolocation coordinates or the like) stored in the repositories 116. The scores 800 can be equal to the distances 804, or can be derived from the distances 804. The server 120 can also generate a set of similarity indicator components 808, e.g., by applying the relevant weighting factor (e.g., 0.3 in this case, as shown in FIG. 4) to the inverse of the ranks obtained from the scores 800.

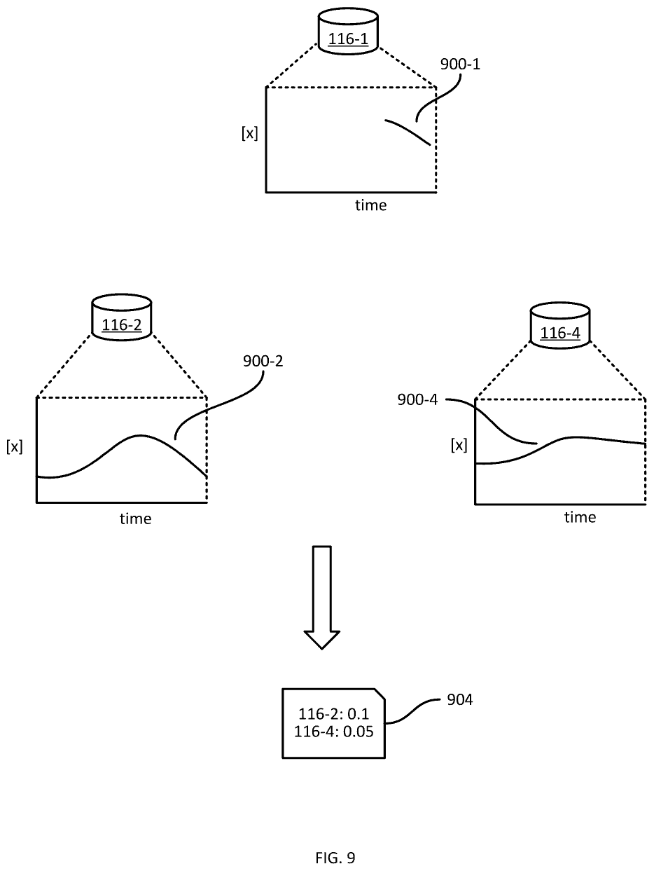

FIG. 9 illustrates a further example performance of block 230, for the evaluation mechanism 400-4. The evaluation mechanism 400-4 involves comparing historical data for the target facility 104-1 with historical data for the candidate facilities 104. For example, the configuration data 136 can specify which historical data to compare, as well as the method of comparison. In the present example, the performance metric [x] is shown plotted over the same time period for each of the target facility 104-1, the candidate facility 104-2, and the candidate facility 104-4. The processor 124 can be configured to determine, for example, a sum of the differences between corresponding data points for the time series 900-1 and 900-2, and a sum of the differences between corresponding data points for the time series 900-1 and 900-4 (e.g., ignoring any portions of the time series 900-2 and 900-4 for which no values exist in the time series 900-1). The sums themselves can be used as scores for the candidate facilities 104-2 and 104-4, or scores may be derived from the sums. A wide variety of other methods can also be used to compare the historical data of the facilities 104, as will occur to those skilled in the art. The processor 124 can then rank the candidate facilities 104-2 and 104-4, e.g., resulting in a weighted set of ranks, or similarity indicator components, 904.

Referring again to FIG. 2, in response to an affirmative determination at block 235, the processor 124 proceeds to block 240. At block 240, the processor 124 is configured to generate similarity indicators for the candidate facilities 104, based on the results of the evaluation mechanisms 400. For example, the similarity indicator components 620, 708, 808, and 904 can be combined to produce a single similarity indicator for each of the candidate facilities 104-2 and 104-4. In other examples, the weighting of ranks from the individual evaluation mechanisms can be performed at block 240. The server 120 can optionally present the similarity indicators, e.g., along with facility identifiers, to an operator via a display or the like.

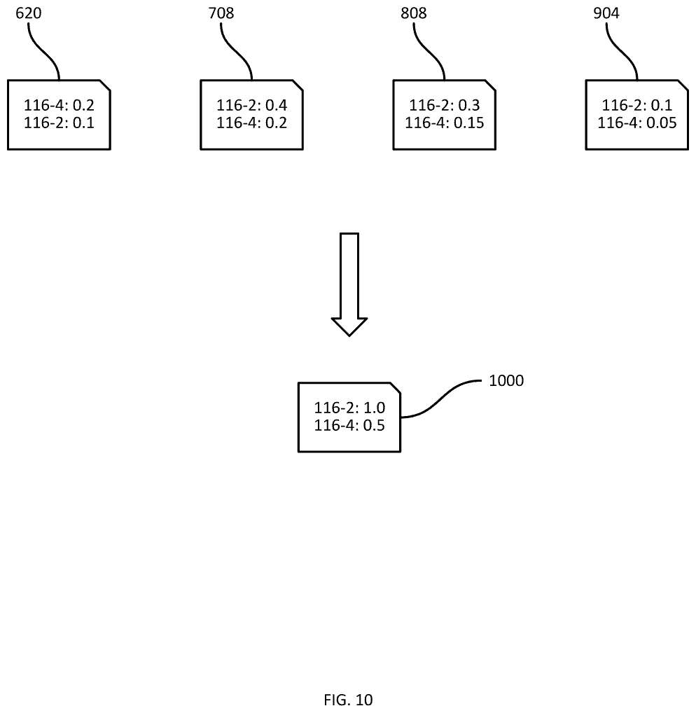

FIG. 10 illustrates an example set of similarity indicators 1000 generated for the candidate facilities 104-2 and 104-4, by combining the similarity indicator components 620, 708, 808, and 904. Responsive to generating the similarity indicators 1000 at block 240, the server 120 can also store the facility identifier associated with the highest similarity indicator in association with the target facility 104-1.

When the performance of the method 200 is associated with a current attempt to generate forecast data, e.g., initiated at block 205, at block 245, the server 120 can optionally retrieve substitute data from the repository 116 corresponding to the candidate facility 104 with the highest similarity indicator from block 240 (e.g., the facility 104-2 in the illustrated example). At block 250, the server 120 can then generate forecast data for the target facility 104-1, data using the retrieved substitute data.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method, comprising:
storing, for a plurality of facilities, respective facility datasets including (i) facility attributes, and (ii) historical time series of values for a plurality of performance metrics;
obtaining an identifier of a target facility among the facilities;
selecting a set of candidate facilities from the plurality of the facilities;
obtaining a similarity evaluation stack configuration;
for each candidate facility, generating a similarity indicator based on (i) the respective facility attributes, (ii) the respective historical time series, and (iii) the similarity evaluation stack configuration;
selecting, based on the similarity indicators, one of the candidate facilities; and
substituting the historical time series of the selected candidate facility for the historical time series of the target facility in a forecasting mechanism.

2. The method of claim 1, wherein selecting the set of candidate facilities includes:
obtaining a proximity parameter; and
selecting the set of candidate facilities based on the proximity parameter.

3. The method of claim 1, further comprising:
prior to selecting the set of candidate facilities, initiating the forecasting mechanism; and
determining that the historical time series for the target facility does not satisfy a forecasting condition.

4. The method of claim 1, wherein the similarity evaluation stack configuration includes a set of evaluation mechanisms; and
wherein generating the similarity indicator for each candidate facility includes:
determining respective ranks of the candidate facility relative to the other candidate facilities for each evaluation mechanism; and
combining the ranks to generate the similarity indicator.

5. The method of claim 4, wherein the similarity evaluation stack configuration defines an order of execution for the evaluation mechanisms; and
wherein determining the respective ranks for each candidate facility is performed according to the order of execution.

6. The method of claim 4, wherein the set of evaluation mechanisms includes an availability mechanism; and
wherein generating the rank for each candidate facility for the availability mechanism includes determining whether the dataset of the candidate facility includes a historical time series for a first performance metric specified in the similarity evaluation stack configuration.

7. The method of claim 6, wherein generating the rank for each candidate facility for the availability mechanism further includes:
generating the rank based on (i) the presence of the historical time series for the first performance metric, and (ii) a count of missing values for the first performance metric in the historical time series.

8. The method of claim 7, further comprising:
when the candidate facility does not include a historical time series for the first performance metric, discarding the candidate facility prior to executing a subsequent one of the evaluation mechanisms.

9. The method of claim 4, wherein the set of evaluation mechanisms includes an attribute matching mechanism; and
wherein generating the rank for each candidate facility includes determining whether the dataset of the candidate facility includes a first facility attribute matching a corresponding facility attribute of the target facility.

10. The method of claim 4, wherein the set of evaluation mechanisms includes a proximity mechanism; and
wherein generating the rank for each candidate facility includes determining a geographic distance between the candidate facility and the target facility.

11. The method of claim 4, wherein the set of evaluation mechanisms includes a historical matching mechanism; and
wherein generating the rank for each candidate facility includes comparing at least one historical time series of the candidate facility to a corresponding historical time series of the target facility.

12. A computing device comprising:
a memory storing, for a plurality of facilities, respective facility datasets including (i) facility attributes, and (ii) historical time series of values for a plurality of performance metrics; and
a processor configured to:
obtain an identifier of a target facility among the facilities;
select a set of candidate facilities from the plurality of the facilities;
obtain a similarity evaluation stack configuration;
for each candidate facility, generate a similarity indicator based on (i) the respective facility attributes, (ii) the respective historical time series, and (iii) the similarity evaluation stack configuration;
select, based on the similarity indicators, one of the candidate facilities; and
substitute the historical time series of the selected candidate facility for the historical time series of the target facility in a forecasting mechanism.

13. The computing device of claim 12, wherein the processor is configured to select the set of candidate facilities by:
obtaining a proximity parameter; and
selecting the set of candidate facilities based on the proximity parameter.

14. The computing device of claim 12, wherein the processor is further configured to:
prior to selecting the set of candidate facilities, initiate the forecasting mechanism; and
determine that the historical time series for the target facility does not satisfy a forecasting condition.

15. The computing device of claim 12, wherein the similarity evaluation stack configuration includes a set of evaluation mechanisms; and
wherein the processor is configured to generate the similarity indicator for each candidate facility by:
determining respective ranks of the candidate facility relative to the other candidate facilities for each evaluation mechanism; and
combining the ranks to generate the similarity indicator.

16. The computing device of claim 15, wherein the similarity evaluation stack configuration defines an order of execution for the evaluation mechanisms; and
wherein the processor is configured to determine the respective ranks for each candidate facility according to the order of execution.

17. The computing device of claim 15, wherein the set of evaluation mechanisms includes an availability mechanism; and
wherein the processor is configured to generate the rank for each candidate facility for the availability mechanism by determining whether the dataset of the candidate facility includes a historical time series for a first performance metric specified in the similarity evaluation stack configuration.

18. The computing device of claim 17, wherein the processor is configured to generate the rank for each candidate facility for the availability mechanism by:
generating the rank based on (i) the presence of the historical time series for the first performance metric, and (ii) a count of missing values for the first performance metric in the historical time series.

19. The computing device of claim 18, wherein the processor is further configured to:
when the candidate facility does not include a historical time series for the first performance metric, discard the candidate facility prior to executing a subsequent one of the evaluation mechanisms.

20. The computing device of claim 15, wherein the set of evaluation mechanisms includes an attribute matching mechanism; and
wherein the processor is configured to generate the rank for each candidate facility by determining whether the dataset of the candidate facility includes a first facility attribute matching a corresponding facility attribute of the target facility.

21. The computing device of claim 15, wherein the set of evaluation mechanisms includes a proximity mechanism; and
wherein the processor is configured to generate the rank for each candidate facility by determining a geographic distance between the candidate facility and the target facility.

22. The computing device of claim 15, wherein the set of evaluation mechanisms includes a historical matching mechanism; and
wherein the processor is configured to generate the rank for each candidate facility by comparing at least one historical time series of the candidate facility to a corresponding historical time series of the target facility.
